(19) United States
(12) Patent Application Publication
(10) Pub. No.: US 2010/0253073 A1
(43) Pub. Date: Oct. 7, 2010

(54) Safety Lock for Cam Lock Fitting

(76) Inventor: David Palmer, San Diego, CA (US)

Correspondence Address: NYDEGGER & ASSOCIATES, 348 OLIVE STREET, SAN DIEGO, CA, 92103, US

(21) Appl. No.: 12/740,093

(22) PCT Filed: Oct. 29, 2008
(86) PCT No.: PCT/US08/81580

§ 371 Date: Apr. 27, 2010

Related U.S. Application Data
(60) Provisional application No. 60/983,479, filed on Oct. 29, 2007.

(51) Int. Cl. F16L 37/18

(52) U.S. Cl. 285/317

(57) ABSTRACT

The invention is a safety lock that keeps the cam lock arms of a female cam lock hose fitting from accidentally opening. It is made of a resilient material and snaps in place over the cam arms from either side of the fitting and can be installed and removed with one gloved hand. It snaps in place to provide a tactile indication of proper placement. The safety lock has a low profile so that it can remain on the fitting when placed in hose tubes and trays. It also protects the cam arms split rings on the ends of the cam arms from damage. An aperture in the leg of the safety lock allows a tether or cable loop to be attached.

### CROSS-REFERENCE TO RELATED APPLICATIONS

This application claims priority from U.S. provisional application Ser. No. 60/983,479 filed on Oct. 29, 2007, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to cam lock hose fittings, and more particularly to a safety lock to secure cam arms on a female cam lock fitting.

2. Description of Related Art

Cam and groove couplings and hose fittings are used in the liquid delivery industry and in many liquid and dry bulk transport applications. A circumferential groove on the male fitting mates with two articulating cams inside the female fitting. The cams typically have elongated cam arms that are rotated out to release the fittings and inward against the outside of the female fitting where cam lobes engage in the groove of the male fitting. The end of the cam arm typically has a split ring. The split ring can be grasped with a finger to open or close the cam arm.

Cam arms are subject to wear and abuse during use. Hoses used for transport and delivery of liquids are often dragged on the ground. The fittings on the end of the hose are dropped and dragged across hard pavement surfaces. The arms become rough and bent and the split rings will bend and develop rough edges and burrs. Gouges to hose trays and tubes are caused by loose and rough cam arms and split rings. Deformed cam arms make it impossible to make a liquid tight seal between fittings. As a result, considerable time is lost trying to operate a damaged fitting. Replacing fittings can be expensive and very inconvenient to operations. A cam lock fitting on a transport hose is manipulated at least twice each delivery, up to twenty to thirty times daily. The average service life of a hose fitting can be as short as 6 months due to normal wear and tear.

The cam arms on the female fitting are also subject to vibration during use. Pulses transmitted through the liquid from the pump can vibrate a cam arm open causing the coupling to separate and a spill will result. In addition, hose trays and tubes used to carry hoses on trucks can be damaged by loose cam arms and bent split rings when hoses are loaded and unloaded and during transport.

A variety of mechanical methods to secure the cam arms of a cam lock fitting have been employed. These include elastic bands, Velcro bands, bungee cords and rings that encircle both cam arms. Most of these wear out quickly or become contaminated with dirt or fuel. Mechanical collars and clips have been developed to secure cam arms. Additionally various buttons, locks and switches have been adapted to mount on the cam arm or the fitting to secure the cam arms closed and require a secondary action before opening the cam. The problem with all of these designs are that when the hoses are handled, dropped or dragged, these devices disengage or get damaged and do not work properly. The also may not engage if the cam arms cannot be fully closed, such as when a new gasket on the female fitting is used. Also, they are difficult to retrofit to existing hose fittings and cannot be fitted universally to fittings of different manufacture. Many of these devices cannot be safely operated with a gloved hand. If a securing device is worn, difficult to use with gloves or broken, they are quickly disabled or discarded by the operator.

Another problem with most devices installed on the fitting is they require the operator to be able to see the device and often require two hands to manipulate it. These devices cannot be operated by feel with one gloved hand when hose connections are located under truck chassis, in wells, confined compartments or other visually inaccessible locations.

What is needed is a reliable apparatus for securing the cam arms and spit rings that is simple and resilient to withstand heavy and frequent use. A device with no moving parts that will not damage hose tubes and trays and will not react or oxidize with the liquids in use is desired. A device that can be installed and removed with one gloved hand and can be tethered is also desired.

### BRIEF SUMMARY OF THE INVENTION

The invention is a safety lock that keeps the cam lock arms of a female cam lock fitting from accidentally opening. It is made of a resilient plastic material and snaps in place over the cam arms from either side of the fitting and can be installed and removed with one gloved hand. In a preferred embodiment, the safety lock has a low profile so that it can remain on the fitting when placed in hose tubes and trays. It also protects the cam arms split rings on the ends of the cam arms from damage. An aperture in the leg of the safety lock allows a tether or cable loop to be attached.

An embodiment of the invention is an apparatus to secure the cam arms of a camlock fitting in a closed position that comprises an arcuate body having two legs, and means for engaging the cam arms of a camlock fitting, where the means for engaging is positioned at the end of each leg.

An aspect of the invention is a ramp member coupled to the means for engaging, where the ramp member slidingly engages the cam arm.

A further aspect of the invention is where the means for engaging comprises a cut out corresponding to the cross section of cam arms in the closed position.

Another aspect of the invention is where the means for engaging comprises a protrusion extending inward from each leg.

A still further aspect of the invention is an elongated handle coupled to the arcuate body.

Another aspect of the invention is where the means for engaging comprises a cylindrical member oriented perpendicular to the legs, and where the center of the cylindrical member comprises an aperture.

A further aspect of the invention is where a ring is positioned at the end of each cam arm, and a bevel cut positioned in each end of the cylindrical member configured to engage the ring.

A yet further aspect of the invention is where the arcuate body having an inside and outside surface, where the inside surface of the arcuate body forms a semi circular chord having a predetermined radius, where the means for engaging comprises a rectangular cut out in each leg, the cut out having a top, a middle and a bottom surface, where the top surface extends to the predetermined radius of the semi circular chord, where the middle surface is positioned to correspond to the closed position of a cam arm, a ramp member coupled to the bottom surface forming a ramp edge, where the ramp edge is positioned inside the predetermined radius formed by the semi circular chord, the ramp edge configured to slidingly engage a cam arm, and an aperture positioned in the ramp member.

Another aspect of the invention is where the outer surface of the arcuate body comprises a plurality of mold cut outs oriented perpendicular to the arcuate body.

A further aspect of the invention is where the cam arms are secured in a position within about 30 degrees of the closed position with the means for engaging.

A still further aspect of the invention is a composite material having an anti static additive.

Another aspect of the invention is where the composite material has a surface resistivity of about 10⁶ ohms per square to about 10¹² ohms per square.

A further aspect of the invention is where the end of the legs are flared to a width of at least one half the length of the cam arms.

Another embodiment of the invention is an apparatus to secure the cam arms of a camlock fitting in a closed position that comprises an arcuate body having two legs, the arcuate body having an inside and outside surface, where the inside surface of the arcuate body forms a semi circular chord having a predetermined radius, where the end of each leg comprises a rectangular cut out facing inside the arcuate body, the rectangular cut out having a top, a middle and a bottom surface, where the top surface extends to the predetermined radius of the semi circular chord, where the middle surface is positioned to correspond to the closed position of a cam arm, a ramp member coupled to the bottom surface forming a ramp edge, where the ramp edge is positioned inside the predetermined radius formed by the semi circular chord, and where the ramp edge is configured to slidingly engage a cam arm.

Another aspect of the invention is where the edges of the rectangular cut out are radiused.

A further aspect of the invention is where the outer surface of the arcuate body comprises a plurality of mold cut outs.

A still further aspect of the invention is where the cam arms are secured within about 30 degrees of the closed position when engaged in the rectangular cut out.

Another aspect of the invention is a composite material having an anti static additive with a surface resistivity of about 10⁶ ohms per square to about 10¹² ohms per square.

A further aspect of the invention is where the rectangular cut out and the ramp member are configured to provide a positive tactile indication when the cam arm is secured.

A yet further aspect of the invention is where the end of the legs are flared to a width of at least one half the length of the cam arms.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a profile view of a safety lock having an semi circular arcuate body that fits around the female cam lock fitting.

FIG. 2 is a profile view of another embodiment of a safety lock with elongated tips.

FIG. 3 is a cross section view of a safety lock having an elongated handle.

FIG. 4 is a top view of the safety lock shown in FIG. 3.

FIG. 5 is a bottom view of the safety lock shown in FIG. 3.

FIG. 6 is a perspective view of another embodiment of a safety lock.

FIG. 7 is a perspective view of a further embodiment of a safety lock similar to the safety lock shown in FIG. 6.

FIG. 8 is a perspective view of a still further embodiment of a safety lock.

FIG. 9 is a side view of the safety lock shown in FIG. 8.

### DETAILED DESCRIPTION OF THE INVENTION

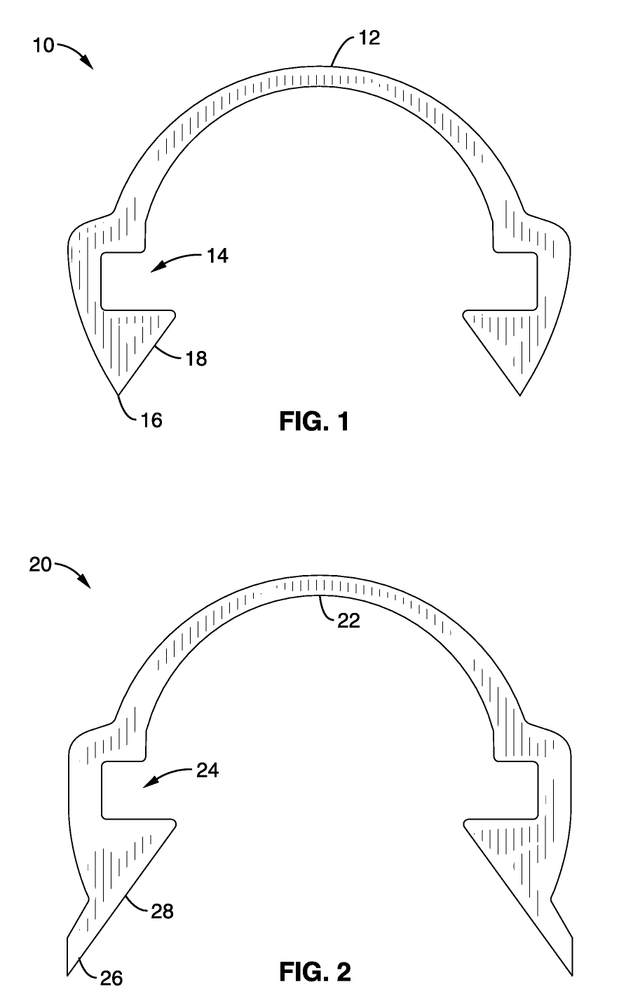

Referring more specifically to the drawings, for illustrative purposes the present invention is embodied in the apparatus generally shown in FIG. 1 through FIG. 9. It will be appreciated that the apparatus may vary as to configuration and as to details of the parts, and that the method may vary as to the specific steps and sequence, without departing from the basic concepts as disclosed herein.

FIG. 1 is a profile view of a safety lock 10 having an semi circular arcuate body 12 that fits around the female cam lock fitting. The radius of the chord formed by arcuate body 12 corresponds to the nominal radius of the cam lock fitting. Near the end of each leg there is a rectangular cam arm cut out 14 that is adapted to fit over each cam arm in the closed position. Near the tip 16 of each leg is a ramp 18 on the inside of the safety lock. The ramp 18 is used to slide over the cam lock arm and snap cut out 14 into position over the cam arm when the clip is pushed onto the cam lock fitting. Ramp 18 also provides a recess between the cam lock fitting body and the safety lock to insert a finger to remove the safety lock. The safety lock is made from a resilient material such as plastic having shape memory properties.

FIG. 2 is a profile view of another embodiment of a safety lock 20. Arcuate body 22 fits around the cam lock fitting. Cam arm cut outs 24 are located near the end of each leg and are positioned to secure the safety lock against the cam arm. Tip 26 is elongated to provide an elongated ramp 28. The elongated ramp and tip provide additional gripping area so a gloved hand or one finger can remove it.

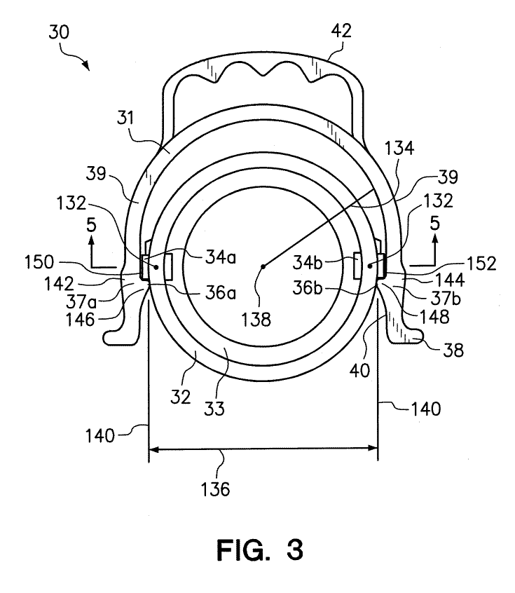

FIG. 3 is a cross section view of a third embodiment of a safety lock 30. Safety lock 30 has an arcuate body and is shown coupled to a standard cam and groove hose fitting 32 with cam arms 34. Instead of cut outs, safety lock 30 has protrusions 36 that extend inside the radius of the chord formed by the arcuate safety lock and snap around each cam arm 34 to hold the clip in place. The tip 38 of each leg is extended outward with a ramp 40 that provides a large finger pull edge so that the clip can be removed while wearing gloves. Note that ramp 40 is slightly curved. In this embodiment, elongated grip handle 42 allows easy removal of the safety lock and stiffens and strengthens the clip.

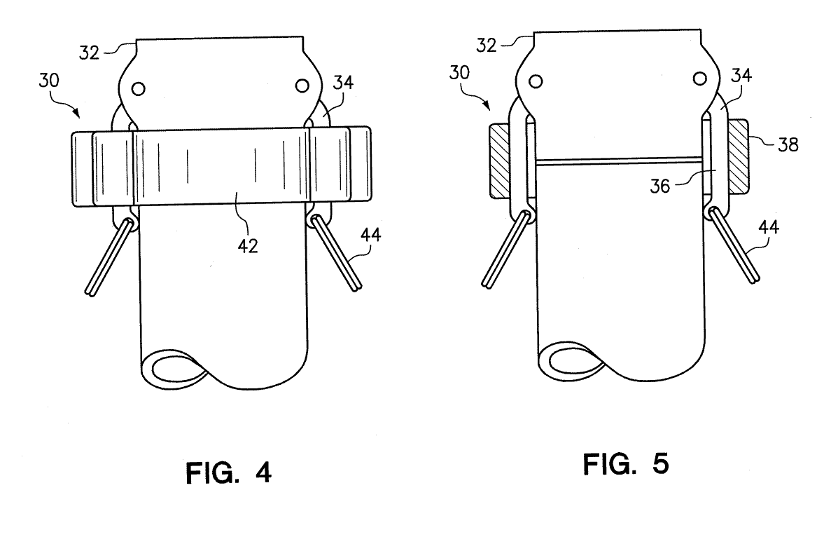

FIG. 4 is a top view of safety lock 30 shown in FIG. 3 securing cam arms 34. Note the split rings 44 at the end of cam arms 34.

FIG. 5 is a bottom view of safety lock 30 shown in FIG. 3 securing cam arms 34.

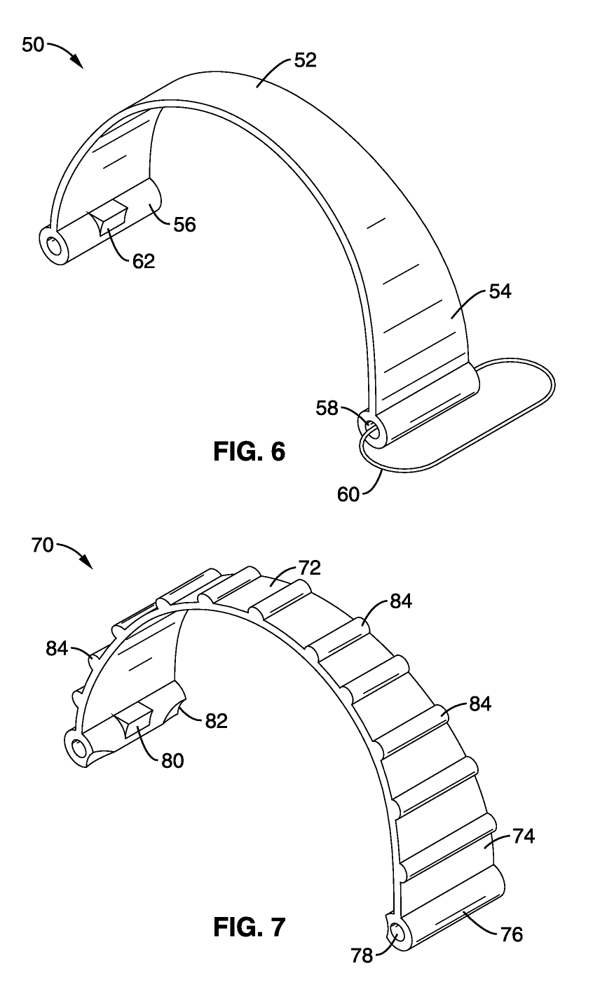

FIG. 6 is a perspective view of another embodiment of a safety lock 50 made of a resilient material having shape memory properties.

Arcuate body 52 has a relatively low profile so the clip can remain in place when the fitting with the safety lock attached is placed in a hose tube or tray. Each leg 54 flares wider near the end and terminates in a cylindrical member 56 oriented on an axis perpendicular to the tangent of each leg 54. Each cylindrical member 56 has an aperture 58 through the axis that can be used with a tether or cable loop 58. The tether or cable loop 60 can be grasped and pulled for removal of the safety lock. The tether or cable loop 60 can also be attached to a dust cap or safety bump (a protective cap with a handle and diameter greater than the diameter of the cam lock fitting) used to protect the end of the cam and groove fitting.

A triangular ramp member 62 is positioned on the inside and center of each cylindrical member 56. The ramp is adapted to slide over the cam lock arm and the edge of the ramp member 62 engages the edge of the cam arm.

FIG. 7 is a perspective view of a further embodiment of a safety lock 70 similar to the safety lock shown in FIG. 6. Safety lock 70 has a low profile body 72 with legs 74 that flare out terminating at cylindrical members 76. Each cylindrical member 76 has a length approximating the length of a cam arm and has an aperture 78 for a tether or cable loop. A ramp member 80 is positioned on the inside and center of each cylindrical member 76.

A beveled cut 82 is made on each end of cylindrical member 76. These beveled cuts 82 are adapted to slide over and secure the split rings found at the ends of the cam arms (see FIG. 4) and prevent the safety lock from sliding off past the slip rings. When the safety lock is mounted on the cam lock fitting, the cylindrical ends 76 cover most of the cam arm and bevel cut 82 secures the split rings against the body of the cam lock fitting. This helps prevent the split rings from rotating outward and grinding against pavement developing rough edges and burrs. These rough edges and burrs are a source of injury to operator's fingers and damage to hose tubes and trays.

In one embodiment, safety lock 70 also has ridges and/or valleys 84 on body 72 that provide a textured gripping surface on the outside of the safety lock for handling with oiled gloves. Safety lock 70 is made of a resilient material such as plastic with shape memory properties.

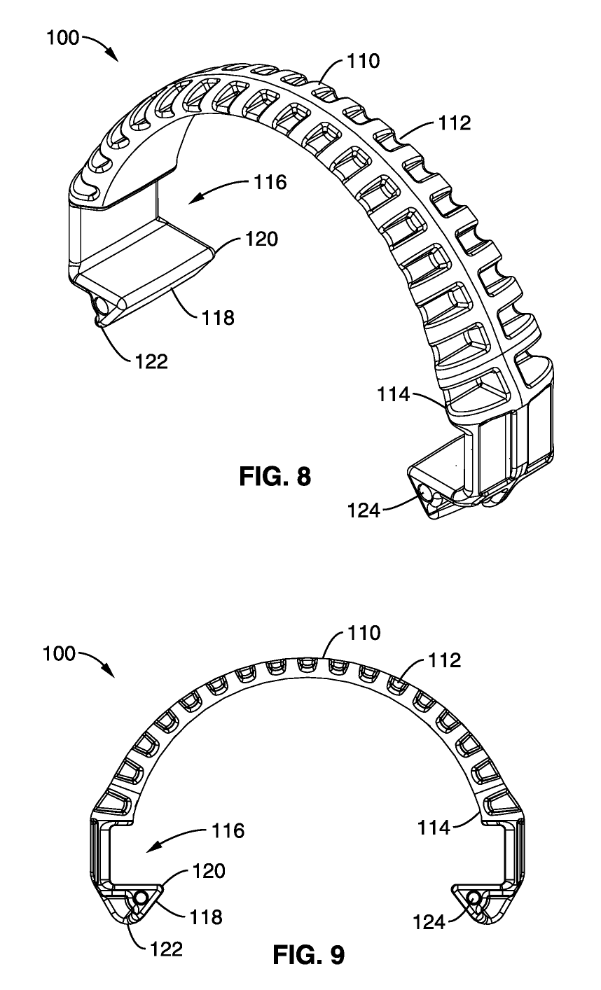

FIG. 8 is a perspective view of another embodiment of a safety lock 100. Safety lock 100 has an arcuate body 110 with small cutouts 112 on the outer surfaces to provide texture for gripping with oiled rubber gloves and to facilitate injection molding. The radius of the cord forming the body 110 of the safety lock corresponds to the nominal radius of the cam lock fitting. Legs 114 flare out towards the end and, in one mode, the width of the flared end is greater than half the length of a cam arm. Legs 114 transition to a rectangular cam arm cutout 116 with smooth surfaces and rounded corners. A smooth ramp 118 oriented to the interior of the safety lock intersects with cam arm cutout 116 at a rounded edge 120 to form a wedge positioned below cam arm cutout 116. Edge 120 is positioned inward of the radius of the arcuate chord formed by body 110. This inward position ensures that the safety lock will not slide on the cam arms past the cam arm split ring (see FIG. 4). Ramp 118 terminates in a rounded tip 122. An aperture 124 is positioned near tip 122 to accommodate a cable loop for pulling the leg of the safety lock or a tether to connect to the fitting, a dust cap or safety bump.

In use, ramp 118 slides over the cam arm and cut out 116 snaps over the cam arm to secure it in the closed position. (see FIG. 4). Safety lock 100 can be installed from either side of the cam lock fitting. The wedge shape of ramp 118 with edge 120 and cut out 116 provides a positive tactile indication that the safety lock has snapped in place over the cam arm. The wedge shape also allows access to tip 122 for removal with a gloved hand or finger on either side. Installation of safety lock 100 can be accomplished without visual contact with the fitting and removal is done by pulling either tip 122 with a finger, cable or tether. Safety lock 100 is made from a durable resilient material with shape memory properties. One example of suitable material is Delron™. Safety lock 100 can be color coded to contrast with existing equipment, provide a visual cue that the safety lock is installed or designate a particular size or type of compatible fitting.

In a further embodiment, safety lock 100 is composed of a composite made from polypropylene, fiber glass and an antistatic additive, having surface resistivity from about 10⁶ to about 10¹² Ω/sq (ohms per square) where square is a dimensionless value. A preferred composite is rated at about 10⁹ Ω/sq for surface resistivity and 40⁷ ω/sq for volume resistivity. For comparison, electrostatic shielding composites range from 10 to 10² ω/sq, conductive composites range from 10² to 10⁵ ω/sq, dissipative composites range from 10⁶ to 10⁹ ω/sq and antistatic composites range from 10⁹ to 10¹² ω/sq. The dissipative and anti static properties of the safety lock are important to prevent static buildup and/or electrical discharge when the safety lock is handled or is removed from the fitting.

In a preferred embodiment, the composite material is a combination of polypropylene, less than 10% of short fiber (3 mm) glass, and an anti-static polymeric additive. An example of an anti-static additive is Ciba Irgastat P18®. In an embodiment for food grade use, the composite material is FDA certified polypropylene and an anti static additive such as CIBA Irgastat P16®.

In one embodiment, the width of cut out 116 does not fit snugly over the cam arm and will fit a variety of fitting made of different manufacturers or materials. Also the depth of cut out 116 past the inner dimension of body 110 is predetermined to secure a cam arm that is positioned within about 30 degrees of the closed position. This situation may occur if the cam arm is only slightly damaged or a new gasket is in place on the female fitting. In another beneficial aspect, safety lock 100 will not provide a tactile snap if one or both cam arms are not within about 30 degrees of the closed position. This is a signal to the operator that the fitting is inoperable and need to be replaced.

FIG. 9 is a side view of safety lock 100 shown in FIG. 8. Note the position of edge 120 inward of the chord formed by arcuate body 110. This extension inward ensures the safety lock does not side past the split ring on the cam arm. Also the width and depth of cut out 116 will accommodate fittings of different manufacture and cam arms positioned within about 30 degrees of fully closed.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus to secure the cam arms of a camlock fitting in a closed position comprising:
an arcuate body having two legs; and
means for engaging the cam arms of a camlock fitting, said means for engaging positioned at the end of each leg.

2. An apparatus as recited in claim 1, further comprising:
a ramp member coupled to said means for engaging;
wherein said ramp member slidingly engages the cam arm.

3. An apparatus as recited in claim 2, wherein said means for engaging comprises a cut out corresponding to the cross section of cam arms in the closed position.

4. An apparatus as recited in claim 2, wherein said means for engaging comprises a protrusion extending inward from each leg.

5. (canceled)

6. An apparatus as recited in claim 2:
wherein said means for engaging comprises a cylindrical member oriented perpendicular to said legs; and
wherein the center of said cylindrical member comprises an aperture.

7. An apparatus as recited in claim 6:
wherein a ring is positioned at the end of each cam arm; and
a bevel cut positioned in each end of said cylindrical member configured to engage said ring.

8. An apparatus as recited in claim 1, further comprising:
said arcuate body having an inside and outside surface;
wherein said inside surface of said arcuate body forms a semi circular chord having a predetermined radius;
wherein said means for engaging comprises a rectangular cut out in each leg;
said cut out having a top, a middle and a bottom surface;
wherein said top surface extends to the predetermined radius of said semi circular chord;
wherein said middle surface is positioned to correspond to the closed position of a cam arm;
a ramp member coupled to said bottom surface forming a ramp edge;
wherein said ramp edge is positioned inside the predetermined radius formed by said semi circular chord;
said ramp edge configured to slidingly engage a cam arm; and
an aperture positioned in said ramp member.

9. An apparatus as recited in claim 8, wherein said outer surface of said arcuate body comprises a plurality of mold cut outs oriented perpendicular to said arcuate body.

10. An apparatus as recited in claim 8, wherein said cam arms are secured in a position within about 30 degrees of the closed position with said means for engaging.

11. An apparatus as recited in claim 8, further comprising a composite material having an anti static additive.

12. An apparatus as recited in claim 11, wherein said composite material has a surface resistivity of about 10⁶ ohms per square to about 10¹² ohms per square.

13. An apparatus as recited in claim 8, wherein the end of said legs are flared to a width of at least one half the length of said cam arms.

14. An apparatus to secure the cam arms of a camlock fitting in a closed position comprising:
an arcuate body having two legs;
said arcuate body having an inside and outside surface;
wherein said inside surface of said arcuate body forms a semi circular chord having a predetermined radius;
wherein the end of each leg comprises a rectangular cut out facing inside said arcuate body;
said rectangular cut out having a top, a middle and a bottom surface;
wherein said top surface extends to the predetermined radius of said semi circular chord;
wherein said middle surface is positioned to correspond to the closed position of a cam arm;
a ramp member coupled to said bottom surface forming a ramp edge;
wherein said ramp edge is positioned inside the predetermined radius formed by said semi circular chord; and
wherein said ramp edge is configured to slidingly engage a cam arm.

15. An apparatus as recited in claim 14, wherein the edges of said rectangular cut out are radiused.

16. (canceled)

17. An apparatus as recited in claim 14, wherein said cam arms are secured within about 30 degrees of the closed position when engaged in said rectangular cut out.

18. An apparatus as recited in claim 14, further comprising a composite material having an anti static additive with a surface resistivity of about 10⁶ ohms per square to about 10¹² ohms per square.

19. An apparatus as recited in claim 18, wherein said rectangular cut out and said ramp member are configured to provide a positive tactile indication when the cam arm is secured.

20. (canceled)

21. A safety lock for use in securing a pair of locking arms of a fitting at an end of a fluid delivery tube, wherein the tube is substantially cylindrical shaped with a diameter “D” and the tube defines a longitudinal axis, wherein the locking arms are each pivotally mounted at respective, diametrically-opposed pivot points on an external surface of the tube, wherein the pivot points are substantially at the distance “D” from each other for respective rotations of the locking arms about parallel axes, and wherein the parallel axes are tangent to the tube and are oriented thereon perpendicular to the longitudinal axis of the tube, the safety lock comprising:
a resilient connecting member having a first end and a second end, wherein the connecting member is structurally biased to substantially maintain the first end at the distance “D” from the second end;
a first locking unit affixed to the first end of the connecting member, wherein the first locking unit is formed with a grip for engagement with one of the pair of locking arms; and
a second locking unit affixed to the second end of the connecting member, wherein the second locking unit is formed with a grip for engagement with the other locking arm, wherein the pair of locking arms are held against the surface of the tube when the locking arms are simultaneously engaged by the first and second locking units.

22. A safety lock as recited in 21 wherein the grip is a recess dimensioned to receive a portion of a locking arm therein.

23. A safety lock as recited in 21 wherein the connecting member is arcuate, and is configured with a radius of curvature “R” relative to the longitudinal axis of the tube, wherein R is greater than half of D (R>D/2).
